(19) United States
(12) Patent Application Publication
(10) Pub. No.: US 2016/0164893 A1
(43) Pub. Date: Jun. 9, 2016

(54) EVENT MANAGEMENT SYSTEMS

(71) Applicant: HEWLETT-PACKARD DEVELOPMENT COMPANY, L.P., Houston, TX (US)

(72) Inventor: Eliav Levi, Yehud (IL)

(21) Appl. No.: 14/895,233

(22) PCT Filed: Jul. 17, 2013
(86) PCT No.: PCT/US2013/050937

§ 371 Date: Dec. 2, 2015

(51) Int. Cl. H04L 29/06; G06F 17/30

(52) U.S. Cl. CPC H04L 63/1416; G06F 17/30528; G06F 17/30595; H04L 63/1425

(57) ABSTRACT

According to an example, an event management system determines context for received events. The event management system generates a context query for an event including event data and transmits the context query to a context determination service. Context may be determined from query results provided by the context determination service.

### BACKGROUND

Today terabits of information on virtually every subject imaginable are stored and accessed across networks. In some cases, events associated with the data are analyzed possibly in real-time to make decisions. Large amounts of data received in continuous data streams may be stored and analyzed to make decisions about the events.

### BRIEF DESCRIPTION OF DRAWINGS

The embodiments are described in detail in the following description with reference to examples shown in the following figures.

FIG. 1 illustrates an example of an event management system.

FIGS. 2A-B illustrate examples of event data.

FIG. 3 illustrates an example of a security information and event management system.

FIG. 4 illustrates an example of a method for determining context for an event.

FIG. 5 illustrates an example of a computer system that may be used as a platform for the event management system or the security information and event management system.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It is apparent that the embodiments may be practiced without limitation to all the specific details. Also, the embodiments may be used together in various combinations.

An event management system according to an example may receive events from multiple data sources. The event management system may store the events and can perform compute-intensive correlation on the events. Rules including conditions may be stored to correlate the events. The event managements system can apply the rules to the events to detect certain types of activities and perform certain functions in response to detecting the activities.

The event management system may determine context for the events. Context may include a meaning of an event. The meaning may not be specifically described in the event data for the event but the meaning may be derived from the event data. Context for an event may be determined from events having similar event data. Also, once context is determined for an event, the event may be related to other events having the same context to provide a better understanding of the events. For example, context may be determined for events to determine whether an event or group of events represent a network security threat. In another example, context may be used for business process decision making. In one example, a context may identify a topic or subtopic that the event is determined to fall into, such as network security threat, or network security threat for server X or distribution of sensitive information.

An event includes event data that may describe an activity or action. The activity or action may occur or be performed on a computer and/or in a computer network. Event data for events may include any data describing and/or otherwise related to an activity or action performed on a computer or in a computer network. The event data may be correlated and analyzed by the event management system to detect certain conditions and to trigger certain actions including alerts or other actions.

In one example, the event data and contexts determined for events may be correlated and analyzed by a security information and event management system (SIEM) to identify network or computer security threats. The activities detected through event correlation may be malicious activities such as attempts to gain unauthorized access to a computer network or a computer. For example, correlation may include detecting events for failed login attempts from the same user across multiple different machines within a 5 minute time period. The activities of the events may be associated with a user, also referred to as an actor, to identify a security threat and the cause of the security threat. Activities may include logins, logouts, sending data over a network, sending emails, accessing applications, reading or writing data, etc. A security threat may include activities determined to be indicative of suspicious or inappropriate behavior, which may be performed over a network or on systems connected to a network.

The event data sources for the event data may include network devices, applications or other types of data sources described below operable to provide event data that may be used to identify network security threats. Event data describing events may be captured in logs or messages generated by the data sources. For example, intrusion detection systems, intrusion prevention systems, vulnerability assessment tools, firewalls, anti-virus tools, anti-spam tools, and encryption tools may generate logs describing activities performed by the source. Event data may be provided, for example, by entries in a log file or a syslog server, alerts, alarms, network packets, emails, or notification pages.

Event data can include information about the device or application that generated the event. An identifier for an event source may be a network endpoint identifier (e.g., an Internet Protocol (IP) address or Media Access Control (MAC) address) and/or a description of the source, possibly including information about the product's vendor and version. The time attributes, source information and other information is used to correlate events with a user and analyze events for security threats.

The event correlation is not limited to detecting network security threats and can be applied to many different applications. For example, transactions for online purchases and context may be correlated to detect certain conditions or bank financial transaction can be correlated to detect certain conditions. The event correlation can be applied to applications that receive large amounts of data that is to be correlated in real time to detect certain conditions in order to perform certain actions. The activities that can be detected are not limited to malicious activities and can be any type of activities that can be detected through application of rules to events.

The event management system may analyze events for all types of systems. For example, enterprise systems may include systems to execute business processes based on received events. In an example related to business processes, a large online retailer may continuously receive events related to online browsing of a registered user and the events are analyzed to make purchase recommendations or the events may include purchase orders that are to be processed. The event management system may analyze the event to perform actions.

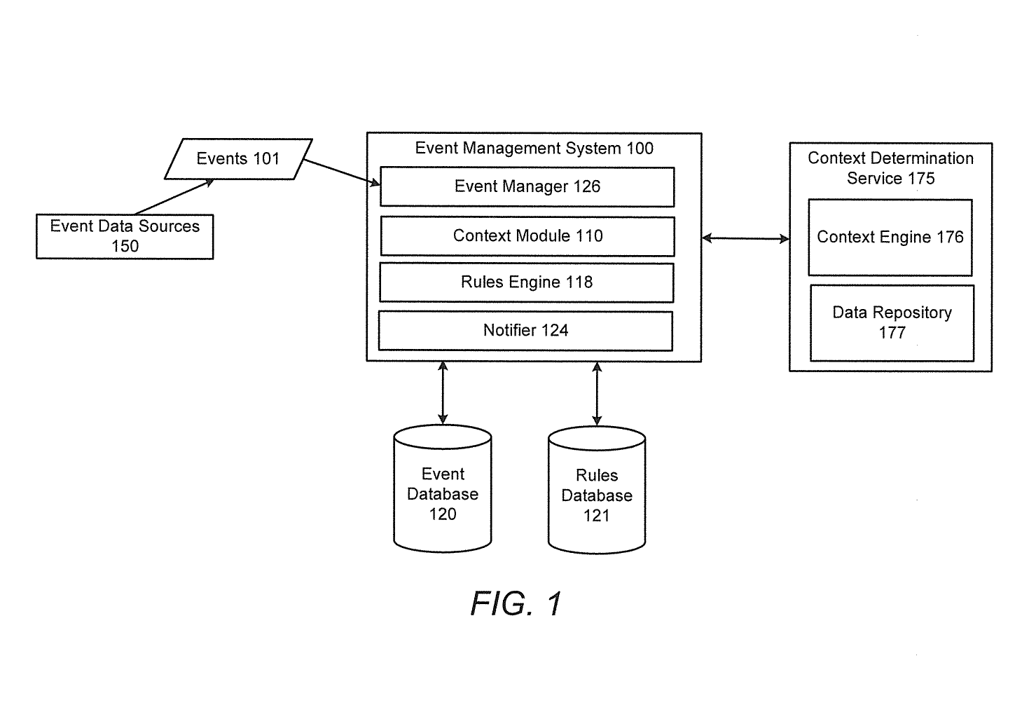

FIG. 1 illustrates an example of an event management system 100. The event management system 100 receives events 101 from event data sources 150, which may include network devices, computers, etc.

The event management system 100 may include an event manager 126, a context module 110, a rules engine 118, event database 120, rules database 121, and notifier 124. The event manager 126 for example receives the events 101 and may store the events 101 in local memory and in the event database 120. Where bi-directional communication with the event data sources 150 is implemented, the event manager 126 may transmit messages to the event data sources 150 for example to request events or to provide other information. The events 101 may be pushed to the event management system 100 from the event data sources 150 or pulled by the event manager 126 requesting the events. If encryption is employed, the event manager 126 decrypts received messages which may include events and encrypts messages transmitted to the event data sources 150.

The context module 110 determines contexts for events. In one example, the context module 110 identifies data for an event and generates a context query from the identified data to send to a context determination service 175. The context determination service 175 determines whether there is any context for the event from the context query and sends results back to the event management system 100. The context module 110 determines from the results whether there is any context for the event. If there is context for the event, the context may be appended to the event. Context may be determined for a single event or a group of events that are related. The context may be determined from event data or data associated with an event. For example, event data may include multiple event fields. An example of some of the event fields may include source IP, destination IP, user action (e.g., failed login attempt, or request to purchase) and event time. Data from one or more of the event fields may be included in the context query sent to the context determination service 175 to determine context for the event. In another example, data associated with an event may be sent to the context determination service 175. For example, event data may identify an email was sent from a source to a destination at a particular date and time. Text from the body of the email may be extracted from the email and/or an attachment from the email may be retrieved from one of the event data sources 150 and provided in the context query sent to the context determination service 175 even though the text and/or the attachment may not be in an event field. This information may be used by the context determination service 175 to determine context for the event.

The context determination service 175 may be part of the event management system 100 or may be external to the event management system 100. For example, the context determination service 175 may include a software application external to the event management system 100 but utilizing event data captured by the event management system 100 to determine context.

In one example, the context determination service 175 may include a context engine 176 and a data repository 177 storing event data and other information related to the context of events. The context engine 176 may determine the context for an event based on data in a received context query and from information in the data repository 177. In one simple example, context engine 176 may execute a keyword search on the data repository 177 using search terms from the received context query. Search results may identify information for the context. For example, a context query may include a server IP address, and the search of the data repository 177 yields results that identify the server IP address as part of a server cluster containing sensitive customer data. In another example, email text or document text from an email attachment is used to search the data repository 177 and yields results that indicate the text refers to a project that includes a trade secret. In these instances, a user may be notified of the context and may execute certain remedial or precautionary actions based on the context and event data.

In another example, the context engine 176 may execute more sophisticated functions to determine context. For example, a clustering function may be used to determine clusters of related data under a topic or sub-topic. The topic or sub-topic may be the context, and if an event is determined to fall into a cluster, the topic or sub-topic for the cluster may be provided as the context. In one example, the context determination service 175 includes AUTONOMY's Intelligent Data Operation Layer (IDOL), which is a software product. IDOL collects indexed data and stores it in a proprietary structure, optimized for fast processing and retrieval of data. As the information processing layer, IDOL forms a conceptual and contextual understanding of content, and automatically analyzes any piece of information which may be provided in many different content formats. By performing operations on content, including summarization, taxonomy generation, clustering, profiling, alerting and retrieval, IDOL can determine and notify of the context of an event based on event data and/or associated information.

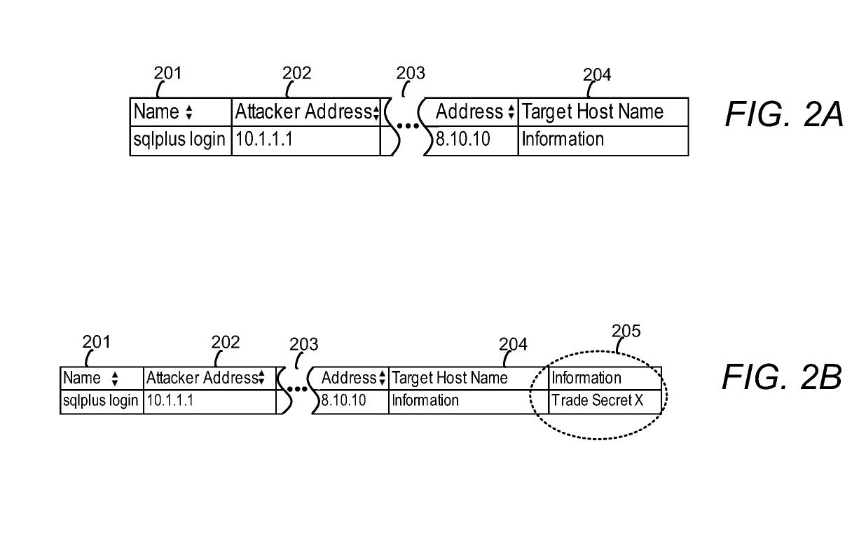

Once context is determined for an event, the context module 110 may append context information to the event. For example, FIG. 2A shows event data in event fields for an event. Event fields may include event name 201, attacker address 202 if an event is determined to be part of an attack, other fields 203, and target host name 204. If context is determined for the event, then the context may be added in a context field 205 of the event, such as shown in FIG. 2B. For example, if the target host name is used to determine the context, the context may return “trade secret X” which may indicate that the target host executes functions for a project related to trade secret X.

Referring to FIG. 1, the rules engine 118 may cross-correlate the event data and/or event summary data with correlation rules stored in the rules database 121. The rules engine 118 may identify a correlation rule associated with an event and context for the event and determine whether an action in the rule is triggered based on conditions in the rule.

A correlation rule may include at least one condition and may include an action to execute if a condition is satisfied. In general, correlation can indicate that different events from different sources are associated with a common incident, as defined by a correlation rule. Correlation may include discovering the relationships among events, inferring the significance of those relationships, prioritizing the events and meta-events, and/or providing a framework for taking action. In one example, a correlation rule includes a procedure or a set of simple or complex conditions which may be combined with other constructs such as aggregation, groupings, and triggers.

A correlation rule may be used in many ways, such as: to evaluate incoming events for specific conditions and patterns; to correlate information from different events using rule correlation as well as other constructs like active lists, session lists, and threat level calculations; to infer meaning about significance of events for example from context; and to initiate actions in response to events. In other words, rules express conditions against which event streams are evaluated. The outcome of the evaluation provides information to derive the meaning out of the event streams. When a match is determined, the rule may initiate an action in response.

In addition to conditions, a correlation rule may further include a threshold (i.e., number of occurrences, running total), a time duration, join criterion, and/or an aggregation criterion. For example:

If (failed login attempt) occurs (from the same source IP address) (10 times) within (1 minute) then (Action).

For this rule, the condition is “failed login attempt,” the threshold number of occurrences is “10,” the time duration is “1 minute,” and the aggregation criterion is “from the same source IP address.”

The rules engine 118 may identify a correlation rule based on event data and/or context. For example, rules may have meta data that identify whether the rule is applicable to a particular context or particular event data and this meta data is used to identify relevant rules. Then, the rules engine 118 may determine whether conditions are met for the relevant rules to trigger actions which may be specified by the rules.

The actions triggered by the rules may include notifications transmitted (e.g., via notifier 124) to designated destinations. For example, security analysts may be notified via consoles, email messages, a call to a telephone, cellular telephone, voicemail box and/or pager number or address, or by way of a message to another communication device.

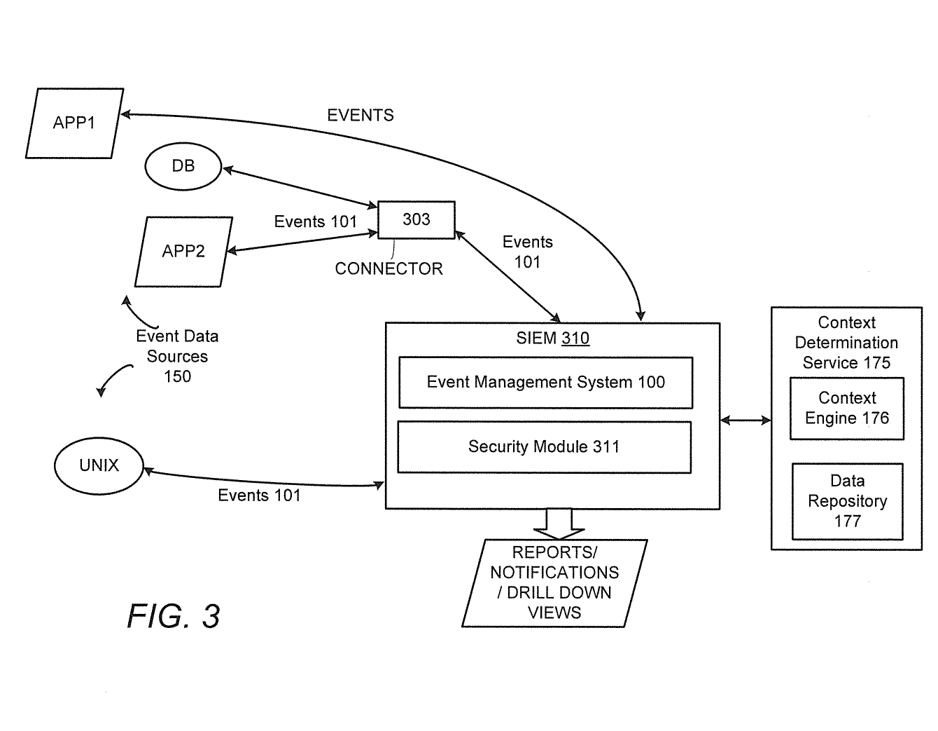

FIG. 3 illustrates a SIEM 310, according to an example. The event management system 100 shown in FIG. 1 may be used in the SIEM 310 to process event data, which may include real-time event processing. The SIEM 310 may process the event data to determine network-related conditions, such as network security threats. For example, security events are monitored that come from the different systems that may provide services to an organization. Typical event contains information about IP addresses, protocol names, suspicious activity (for example, password brute force attack). Each event may be appended with context determined by the context determination service 175 as described with respect to FIG. 1. The security module 311 may use the context information and event data to determine security-related actions, such as to identify a threat or elevate a threat to a higher priority. For example, if the security module 311 determines from the context that a server storing sensitive information is possibly the subject of a brute force attack, the security module 311 may implement actions, such as disconnecting the server from the network. In one example, the security module 311 may be implemented by the event management system 100 executing rules when certain conditions are detected, such as implementation of correlation rules.

The event data sources 150 generate event data for events, which are collected by the SIEM 310. The event data sources 150 may include network devices, applications running on servers or other computer systems or other types of data sources operable to provide event data that may be analyzed. Event data may be captured in logs or messages generated by the event data sources 150. Event data is retrieved for example from data source logs. Event data may be provided, for example, by entries in a log file or a syslog server, alerts, alarms, network packets, emails, or notification pages. The event data sources 150 may send messages to the SIEM 310 including event data.

Event data can include event fields for information about the source that generated the event and information describing the event. For example, the event data may identify the event as a user login. Other event fields in the event data may include when the event was received from the event source (“receipt time”). The receipt time is a date/time stamp. The event fields may describe the source, such as an event source is a network endpoint identifier (e.g., an IP address or MAC address) and/or a description of the source, possibly including information about the product's vendor and version. The date/time stamp, source information and other information may then be used for correlation performed by the event management system 100. The event fields may include meta data for the event, such as when it took place, where it took place, the user involved, etc.

Examples of the event data sources 150 are shown in FIG. 1 as Database (DB), UNIX, App1 and App3. DB and UNIX are systems that include network devices, such as servers, and generate event data. App1 and App3 are applications that generate event data. App1 and App3 may be business applications, such as financial applications for credit card and stock transactions, information technology applications, human resource applications, or any other type of application.

Other examples of event data sources 150 may include security detection and proxy systems, access and policy controls, core service logs and log consolidators, network hardware, encryption devices, and physical security. Examples of security detection and proxy systems include intrusion prevention systems (IPSs), vulnerability assessment tools, anti-virus tools, anti-spam tools, multipurpose security appliances, vulnerability assessment and management, anti-virus, honeypots, threat response technology, and network monitoring. Examples of access and policy control systems include access and identity management, virtual private networks (VPNs), caching engines, firewalls, and security policy management. Examples of core service logs and log consolidators include operating system logs, database audit logs, application logs, log consolidators, web server logs, and management consoles. Examples of network devices include routers and switches. Examples of encryption devices include data security and integrity. Examples of physical security systems include card-key readers, biometrics, burglar alarms, and fire alarms. Other data sources may include data sources that are unrelated to network security.

The connector 303 may include code comprised of machine readable instructions that provide event data from an event data source to the SIEM 310. The connector 303 may provide efficient, real-time (or near real-time) local event data capture and filtering from one or more of the event data sources 150. The connector 303, for example, collects event data from event logs or messages. Connectors may not be used for all the event data sources 150.

Correlation performed by the SIEM 310 may include discovering the relationships between events, inferring the significance of those relationships, e.g., by generating meta events, prioritizing the events and meta events, and providing a framework for taking action. The SIEM 310 also supports response management, ad-hoc query resolution, reporting and replay for forensic analysis, and graphical visualization of network threats and activity.

The SIEM 310 may examine received events to determine which (if any) of the various correlation rules processed in the SIEM 310 may be implicated by a particular event or events. A correlation rule may be considered implicated if an event under test has one or more attributes that satisfy, or potentially could satisfy, one or more rules, which may be based on event data and/or context. For example, a rule is considered implicated if the event under test has a particular source address from a particular subnet that meets conditions of the rule. Events may remain of interest in this sense for designated time intervals associated with the rules and so by knowing these time windows events can be stored and discarded as warranted. The SIEM 310 may communicate or displaying reports or notifications about events and event processing to users.

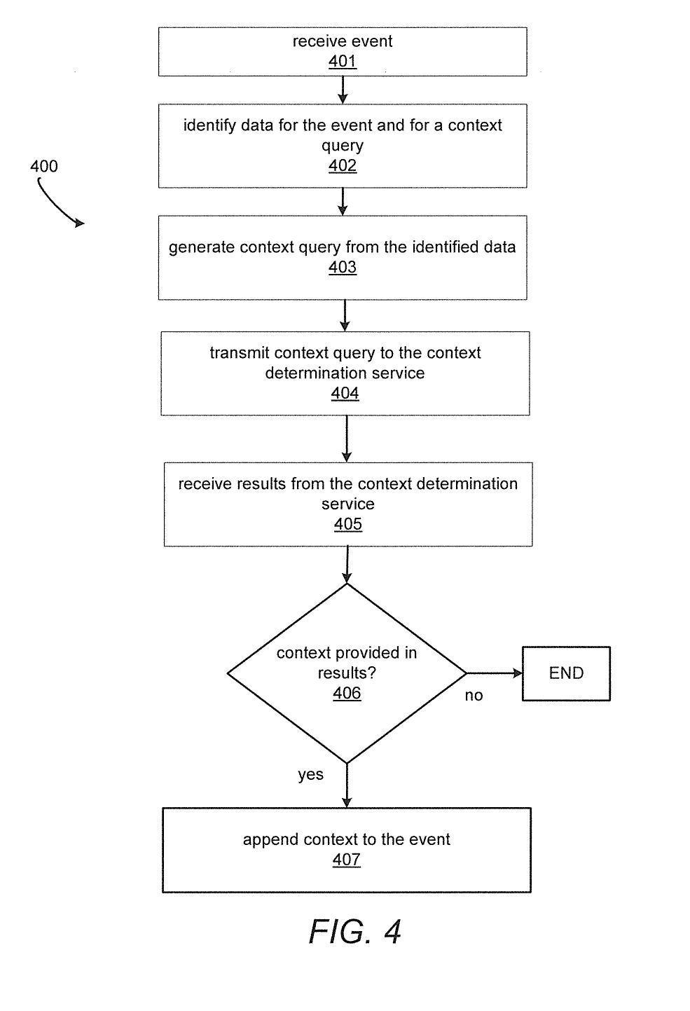

Method 400 shown in FIG. 4 describes determining context for events. The method 400 may be performed by the event management system 100 shown in FIGS. 1 and 3 or other systems.

At 401, the event management system 100 receives an event and at 402 identifies data for the event and for a context query. For example, event data in the event may be included in the context query. In another example, the event may be associated with other data that is included in the context query with or without event data. For example, if the event identifies an email sent from one user to another user, text in the body or subject of the email or an attachment to the email may be included in the context query. The event management system 100 may have to request the other data associated with the event. For example, the event management system 100 may get the email text or attachments from an email server.

At 403, the event management system 100 generates a context query from the data identified at 302. The context query is information that can be used to determine context for the event. The context query for example includes the identified data from 302 and is transmitted at 404 to the context determination service 175. A context determination service is any system that can determine context from a context query.

At 405, the event management system 100 receives results from the context determination service 175 in response to the context query and at 406 the event management system 100 determines whether a context is provided in the results. The results may or may not identify a context from the information in the context query. In some cases, the context determination service 175 may not be able to determine the context because there is insufficient matches between the context query and context information stored at the context determination service 175. In one example, the context determination service 175 may determine clusters from historic event data to identify contexts, and if information in the context query cannot be matched to a cluster with minimum accuracy, the context determination service 175 may return results indicating that no context can be determined. If context can be determined by the context determination service 175, the context is sent to the event management system 100 in the results. The context may identify additional meaning for the event, such as whether event is related to a particular topic or subtopic or other information associated with the event.

At 407, if the context is determined from the results, the event management system 100 appends the context to the event. FIG. 2B shows an example of appending the context to the event.

The event management system 100 may determine context for each event it receives or for a group of the events it receives from the event data sources 150 according to the method 400. In one example, the context is determined for a set of correlated events. For example, the event management system 100 applies a correlation rule to determine a set of correlated events that are related. For example, the event management system 100 applies a correlation rule to determine whether a set of received events are potentially related to an attempt to gain unauthorized access to a server. For example, a correlation rule may specify that if a certain number of failed login attempts occur on the same subnet occur within a 5 minute time period, these events are to be analyzed as a group and a system administrator is to be notified of a potential security threat. The event management system 100 may generate a context query including event data from all the events or most of the events to determine the context for the events from the context determination service 175. Multiple contexts may be returned in the results. For example, one context may specify brute force attack and another context may specify that the subnet is associated with projects that utilize sensitive data. The context may be appended to the events and a system administrator may be notified of the contexts. Also, correlation rules may be implicated to trigger these actions or other actions based on the contexts.

As described above with respect to 403, the event management system 100 may generate a context query from the data identified at 302. In one example, the event management system 100 may implement procedures or policies to determine whether to submit a context query. For example, the event management system 100 may not determine context for single events but instead determines context for a set of events that are correlated because they are determined to have common attributes or satisfy predetermined criteria. In another example, the event management system 100 may determine context for a single event if its event data meets predetermined criteria. For example, context may be determined for events from particular event data sources or for events concerning particular computers. If the event management system 100 determines not to determine context for a particular event, the event may still be correlated with other events based on correlation rules.

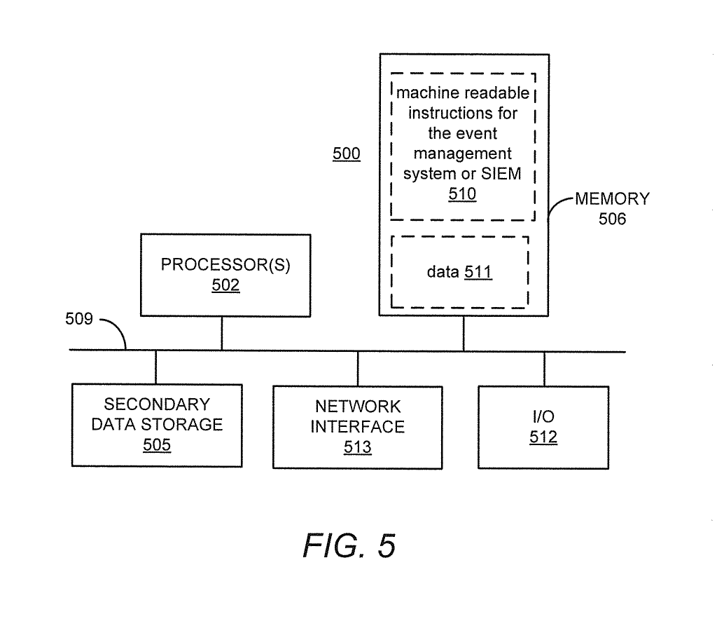

FIG. 5 shows a computer system 500 that may be used with the examples described herein. The computer system 500 may be used as a hardware platform for the event management system 100 and the SIEM 310. The computer system 500 may execute, by one or more processors or other hardware processing circuits, the methods, functions and other processes described herein. These methods, functions and other processes may be embodied as machine readable instructions stored on a non-transitory computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 500 includes at least one processor 502 that may execute machine readable instructions performing some or all of the methods, functions and other processes described herein. The computer system 500 also includes data storage. The data storage may include memory 506, such as random access memory (RAM). For example, machine readable instructions 510 may reside in the memory 506 during runtime. The machine readable instructions 510 may perform one or more of the methods and other functions for the event management system 100 or the SIEM 310. Also, data 511, such as event data, may be stored in the memory 506. The data 511 may include any information used by the event management system 100 or the SIEM 310. The computer system 500 may include a secondary data storage 505, which may be non-volatile and stores the machine readable instructions 510 and any other information used by the event management system 100 or the SIEM 310. Commands and data from the processor 502 are communicated over a communication bus 509. The computer system 500 may include an I/O device 512, such as a keyboard, a mouse, a display, etc. The computer system 500 may include a network interface 513 for connecting to a network and network devices and computers. Other known electronic components may be added or substituted in the computer system 500 and the computer system 500 may not include all the components shown in FIG. 5.

While the embodiments have been described with reference to examples, various modifications to the described embodiments may be made without departing from the scope of the claimed features.

What is claimed is:

1. An event management system comprising:
a data storage device to store events received from a plurality of event data sources; and
at least one processor to
identify data for at least one received event to include in a context query;
generate the context query including the identified data;
transmit the context query to a context determination service;
receive query results of the context query from the context determination service;
determine whether a context is provided in the query results, wherein the context describes additional meaning for the at least one event; and
append the context to the at least one event in response to determining the query results include the context.

2. The event management system of claim 1, wherein the at least one processor is to:
determine whether a correlation rule from a plurality of stored correlation rules is associated with the at least one event and the context for the at least one event;
in response to determining the correlation rule is associated with the at least one event, determine whether the correlation rule triggers an action based on the context and the at least one event; and
execute the action in response to determining the context and the at least one event trigger the action according to a condition in the rule.

3. The event management system of claim 1, wherein to identify the data for the at least one event, the at least one processor is to:
determine whether additional information for the context query is associated with the at least one event;
request the additional information from an event data source of the plurality of event data sources in response to determining the additional information is associated with the at least one event; and
include the additional information in the context query in response to receiving the additional information from the event data source.

4. The event management system of claim 1, wherein to identify data for the at least one received event to include in the context query, the at least one processor is to:
determine whether the at least one event includes information to include in the context query;
in response to determining the at least one event does not include the information for the context query, determine a correlation rule from the plurality of stored correlation rules for the at least one event;
determine whether the correlation rule triggers an action based on event information in the at least one event; and
execute the action in response to determining the at least one event triggers the action according to a condition in the correlation rule and the at least one event information.

5. The event management system of claim 1, wherein the at least one event comprises a set of received events and the at least one processor is to:
apply a correlation rule of the plurality of rules to the received events to identify the set of received events.

6. The event management system of claim 5, wherein to identify the data to include the context query, the at least one processor is to identify the data from information associated with all the events in the set of received events.

7. A security information and event management system comprising:
a network interface to receive events from network devices and computers via a network, wherein each event includes event information describing an action associated with one of the network devices or computers;
a data storage device to store the received events; and
at least one processor to
for each event, determine whether to generate a context query for the event based on event data for the event, and in response to determining to generate the context query, generate and transmit the context query for the event to a context determination service, wherein the context query includes the event data or other data associated with the event;
receive query results from the context determination service based on the context queries;
determine contexts from the query results for the events for which the context queries were transmitted to the context determination service; and
determine from the event data and the contexts whether the events are associated with a security threat.

8. The security information and event management system of claim 7 comprising:
a rules database to store correlation rules; and
the at least one processor is to identify a correlation rule from the rules database associated with at least one of the received events based on the event data for the at least one received event the context for the at least one received event, and determine whether the event is associated with the security threat from the identified correlation rule.

9. The security information and event management system of claim 8, wherein the at least one processor is to aggregate received events having similar event data according to the identified correlation rule, and determine whether a condition in the correlation rule is satisfied based on the aggregated events to determine whether the security threat exists.

10. The security information and event management system of claim 7, wherein the security threat comprises at least one of access or attempted access to information predetermined to be a security risk or distribution of the information predetermined to be the security risk.

11. The security information and event management system of claim 7, wherein to determine the contexts, the at least one processor is to:
determine whether the contexts are provided in the query results; and
in response to determining the contexts are provided in the query results, append each context to the corresponding event.

12. The security information and event management system of claim 7, wherein to determine whether to generate the context query for the event, the at least one processor is to identify a set of the received events based on a correlation rule and generate the context query for all the events in the set based on the event data for all the events.

13. The security information and event management system of claim 7, wherein each of the contexts for the events describes additional meaning for the corresponding event not provided in the event data.

14. A non-transitory computer readable medium including machine readable instructions executable by at least one processor to:
receive an event at a management system;
identify data for the event to include in a context query;
generate and transmit a context query, including the identified data, to a context determination service;
receive query results for the context query from the context determination service;
determine context for the event from the query results; and
append the context to event data for the event.

15. The non-transitory computer readable medium of claim 12, wherein the machine readable instructions are executable to:
determine a correlation rule from a plurality of stored correlation rules for the context and the event;
determine whether the correlation rule triggers an action based on the context and the event; and
execute the action in response to determining the context and the event trigger the action according to a condition in the rule.
